(19) United States
(12) Patent Application Publication
(10) Pub. No.: US 2002/0123905 A1
(43) Pub. Date: Sep. 5, 2002

(54) Clinical operational and gainsharing information management system

(76) Inventors: Joane Goodroe, Norcross, GA (US); Douglas A. Murphy, Atlanta, GA (US)

Correspondence Address: Wm, Brook Lafferty, Esq., Troutman Sanders LLP, Suite 5200, 600 Peachtree Street, NE, Atlanta, GA, 30308-2216, US

(21) Appl. No.: 09/736,138

(22) Filed: Dec. 13, 2000

(51) Int. Cl. G06F 17/60

(52) U.S. Cl. 705/2; 705/7; 705/11; 705/3

(57) ABSTRACT

A clinical information management system. The clinical information management system is implemented by allocating 310 resources and conducting 320 medical procedures. The data from allocating the resources and conducting medical procedures is collected 330 in a database. After the completion of each medical procedure, work and cost reduction opportunities are identified 340 to establish 350 a benchmark for the average utilization of resources for a particular type of procedure once a benchmark is established, particular types of procedures may be standardized 360 to include only the necessary resources which are then requisitioned 370 for future procedures. Data is collected and stored for a clinical procedure. Waste and cost reduction opportunities are identified; resulting in the establishment of a benchmark. The clinical procedure is then standardized based upon the benchmark. Resources are requisitioned based upon the standardized procedure.

### TECHNICAL FIELD

The present invention relates to the management of clinical operations and, more particularly, relates to identifying practice patterns to establish benchmark costs to facilitate resource allocation and utilization.

### BACKGROUND OF THE INVENTION

Currently, the healthcare industry struggles to provide cost effective management of physicians and their medical practices. Generally, physicians strive to provide the best medical care available to their patients. Often the best medical procedures and equipment are required to improve the health of patients. However, the best procedures and equipment are usually the most expensive. Therefore, the physicians are often not permitted to, or are even discouraged from use of, expensive procedures and devices. The healthcare industry is then left in a quandary over how to provide the best healthcare and still turn a profit.

Therefore, there is a need for an improved healthcare management system capable of identifying cost savings opportunities to reduce waste while improving patient care.

### SUMMARY OF THE INVENTION

The present invention provides a healthcare management system which measures operational efficiencies and effectiveness by tracking the supplies and materials used in clinical procedures by procedure, doctor, and hospital, by providing information as to actual and projected costs, and indicating the resources needed. The present invention also establishes preferred practice patterns based upon standardized practice patterns to provide healthcare managers with a competitive advantage. Thus, clinical practices may reward physicians' efforts to reduce costs with a share of the clinic's savings. This practice is commonly referred to as “gainsharing.”

Generally described, the present invention includes a method for measuring the operational efficiency and effectiveness of a clinical practice in order to predict an outcome such as expenses and cost savings opportunities. Data is collected from clinical procedures performed at the point of the procedure. At least one benchmark characteristic is established based upon the collected data collected. Subsequent clinical procedures are standardized based upon the benchmark characteristic.

According to one aspect of the invention, resources utilized in clinical procedures may be requisitioned and allocated based upon the benchmark characteristic.

### BRIEF DISCRIPTION OF THE DRAWINGS

FIG. 1 illustrates a plurality of medical facilities operating in a network according to an exemplary embodiment of the present invention.

FIG. 2 illustrates an exemplary embodiment of the present invention operating in the environment of a personal computer interfacing with a network.

FIG. 3 illustrates one embodiment of a flowchart of a method for measuring operational efficiency and effectiveness of a clinical practice.

FIG. 4 illustrates one embodiment of a flowchart of a method according to one embodiment of the present invention.

FIG. 5 illustrates an exemplary embodiment of the present invention operating within the environment of the Internet on a web site.

Similar reference characters refer to similar parts throughout the several views of the drawings.

### DETAILED DESCRIPTION

The present invention provides a system for identifying practice patterns to establish benchmark costs and facilitate resource allocation and utilization. Preferably, the present invention is implemented on a network utilizing group applications such as an intranet or on the Internet as a web-based application. Also, the network implementing the present invention may interface with other networks such as, but not limited to, billing, transcription and inventory networks.

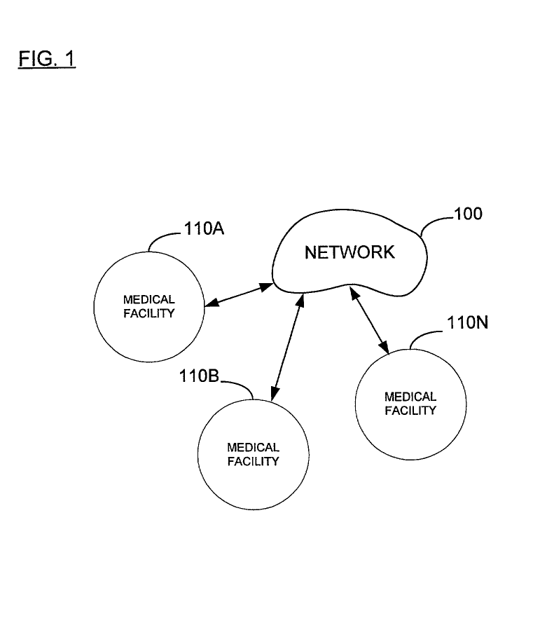

Referring now to the drawing in which like numerals indicate like elements throughout the several views, FIG. 1 illustrates an exemplary embodiment of a computer network 100 connecting a plurality of medical facilities 110A through 110N used by, or for medical professionals.

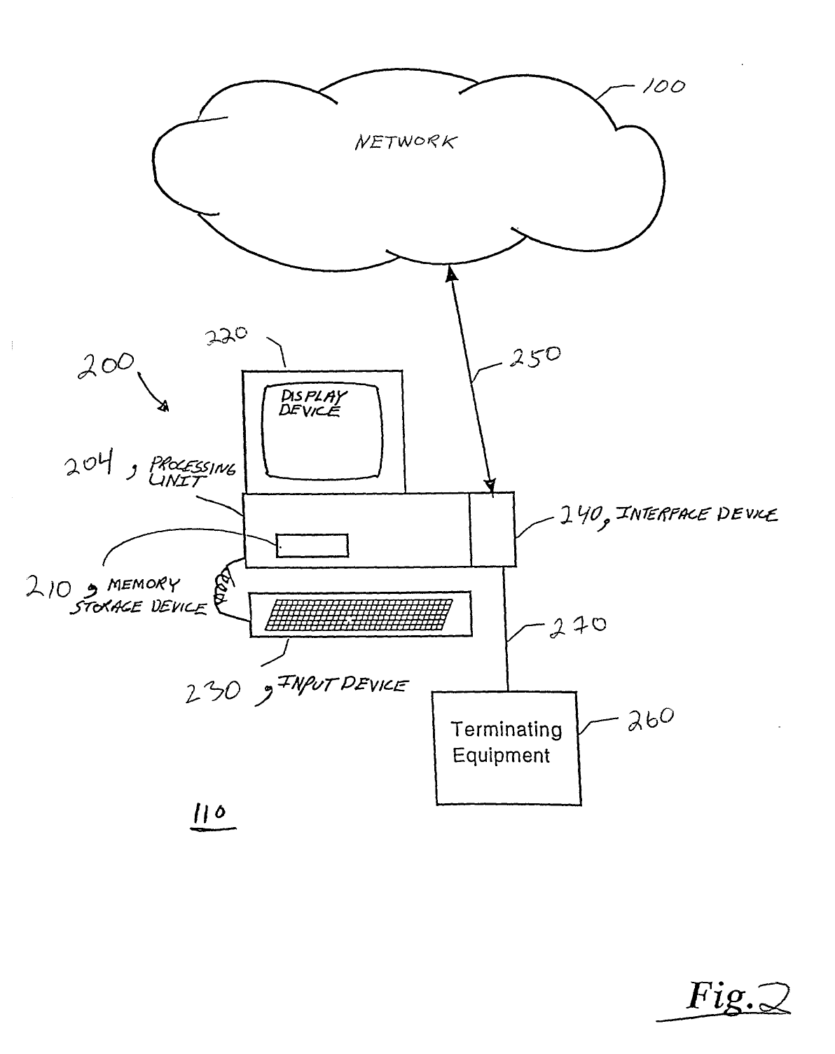

As shown generally in FIG. 2, each medical facility 110 includes a computer 200. The computers 200 of the various medical facilities 110 are connected to each other over the network 100. Each computer 200 generally consisting of a processing unit 204, to a memory storage device 210, a display device 220 and a user input device 230. Each computer 200 also has or is connected to an interface device 240, which provides access to the network 100. The interface device 240 may be, for example, a modem, a T1-line interface, a local ava network (LAN) interface, or other interface, depending upon the requirements of the network 100. This device 240 thus provides for real-time transfer of information to and from its associated computer 200.

The memory storage device 210 stores the operating program or program module for implementing an exemplary embodiment of the present invention.

In one embodiment, the computer 200 is in communication with a coordinating server that is designated for the exchange of information. Although FIG. 2 illustrates a single workstation, computer 200 in FIG. 2 could function as the coordinating server for several other computer 200 (not shown) at the same medical facility, alternatively, several computers could function as servers or as back-up servers if there is a large number of computers 200. The network is designed to communicate with independent workstations at different locations that all read from the common coordinating server. Periodic updates are used system-wide to provide current information to all locations on the network and to maintain system integrity. Update frequency is determined based on system demands.

One or more program modules to implement the present invention may be kept on the server. In an exemplary embodiment, the network 100 is the Internet accessed via an Internet Service Provider. The computers communicate with one another via an Internet's File Transfer Protocol, commonly referred to as FTP. Alternatively, other protocols or formats, such as the HTTP protocol of the Web can be used for uploading and downloading files.

The present invention includes a database which is a collection of structured data organized in a disciplined fashion so that quick access is provided to information of interest. A copy of the database may reside on the coordinating server or be distributed to each location via the network, where it resides on each workstation (computer 200), at each particular location. In the latter case, data is written to the server which mirrors the distributed copy of the database. Moreover, the present invention may include a plurality of databases related to each other by a management system such as a database server utilizing software to create, store, retrieve, change, manipulate, sort, format and print the information from any database. In such case, the database server may be the coordinating server as described above.

In the present invention, accurate clinical data is required for decision support. The ability to compare and distinguish one medical facility and one doctor from another, as well as one medical procedure from another, is important for the continuous update and improvement of patient care. Benchmarks are established to calculate and validate accuracy performance of medical technology and clinical decisions. The established benchmarks are derived from the following categories which may include, but are not limited to, Quality, Clinical Presentation, Diagnostic Procedure Indication, Interventional Procedure Indication, Diagnostic Procedure Results, Interventional Procedure Results, Length of Stay, and Medication Use. A list of typical benchmarks in these eight categories is provided below.

Each quarter, all participating facilities receive an electronic update of the latest regional, national and best-in-class benchmarks. Benchmarks are based upon patient encounters from all participating facilities and are calculated and validated for accuracy on a quarterly basis by university-based, Ph.D.-level analysts. These benchmarks are presented as report overlays on pre-formatted reports, providing an easily demonstrated competitive advantage when negotiating with managed care organizations or marketing services to purchasers of care.

| | |
|---|---|
| Quality | |
| Mortality | Tamponade |
| CVA | Emergency PCI |
| Hematoma | Successful Coronary Intervention |
| Excessive Contrast | Part. Successful Coronary Intervention |
| Renal Failure | Return to Cath Lab |
| Vascular | Return to Cath Lab Post Discharge |
| CAB after PCI | Hematoma - PVD |
| CAB | Minor Contrast Reaction - PVD |
| Abrupt Closure | Major Contrast Reaction - PVD |
| Q-Wave MI | CVA - PVD |
| CHF | Mortality - PYD |
| VT/VF | |
| Clinical Presentation | |
| Unstable Angina | MI >6 hours ≦24 hours |
| Stable Angina | MI >24 hours ≦7 days |
| Atypical | Thrombolysis |
| NYHC I | Objective Evidence of Ischemia |
| NYHC II | Cyanosis |
| NYHC III | Previous PCI |
| NYHC IV | Previous CAB |
| MI ≦ 6 hours | Previous Valve |
| Diagnostic Procedure Indication | |
| Ischemic Heart Disease | Cardiogenic Shock |
| Positive Functional Test(s) | Valvular Heart Disease |
| Cardiac Arrhythmia | Congenital Heart Disease |
| Congestive Heart Failure | Heart Disease of Other Etiology |

Procedure and Data Analysis reports are generated from the data entered and stored in the database. The reports are preferably preformatted reports which include, but are not limited to, Clinical Outcomes Reports, Procedure Results Reports, Patient Profiles Reports, Medication Use Reports, Length of Stay Reports, and Demographic Reports. A list of the typical contents of the reports is provided below.

Clinical Outcomes Reports

Interventional Patient Outcomes by Physician

Interventional Patient Outcomes by Procedure

Interventional Patient Repeat Visits by Physician

Interventional Patients with Repeat Procedures by Physician

Interventional Patients with Repeat Procedures by Procedure

Interventional Patients with Repeat Procedures by Major Vessel Segment

Interventional Repeat Procedure Rate by Procedure and Vessel Segment

Interventional Patient In-Lab vs. Out-of-Lab Morbidities

Diagnostic Patient In-Lab vs. Out-of-Lab Morbidities

Complications at Site of Intervention(s) by Procedure

Major Morbidities

Major Morbidities by Physician

Minor Morbidities

Minor Morbidities by Physician

Major Morbidities for PVD Procedures

Minor Morbidities for PVD Procedures

Mean Fluoro Time by Physician

ORYX—Contrast Intake ≧300 cc

ORYX—Coronary Compromise during Interventional Procedures

ORYX—Hematomas during Cath Lab Procedures

ORYX—Major Events during Cath Lab Procedures

ORYX—Patient Outcome for Coronary Interventions

ORYX—Repeat Coronary Procedures Post-Discharge

ORYX—Repeat Coronary Procedures within the Same Admission

Repeat Interventional Procedure Rate by Lesion Location

Patients proceeding to CAB or Valve Surgery

Risk Factors by Physician

Procedure Results Reports

Diagnostic Procedure Findings

Diagnostic Procedure Findings by Physician

Interventional Outcome by Vessel

Left Ventricular Function by Physician Device Purpose

Device Use by Vessel

Patient Profiles Reports

Patient Clinical Presentation

Patient Risk Factor Profile by Physician

Diagnostic Patient Clinical Presentation

Diagnostic Patient Procedure Indications

Interventional Patient Clinical Presentation

Interventional Patient Procedure Indications

Interventional Procedure Lesion Classification by Physician

Cardiovascular Interventional Patient History

Angina Class by Physician

Patients by Referring Physician

Medication Use Reports

Medication Utilization in the Cath Lab by Physician

Medication Utilization in the Cath Lab by Procedure

Medication Utilization during Hospitalization by Clinical Presentation

Medication Utilization during Hospitalization by Physician

Medication Utilization during Hospitalization by Procedure Indication

Medication Utilization during Hospitalization by Procedure

Medication Utilization during at Discharge by Clinical Presentation

Medication Utilization during Hospitalization by Procedure

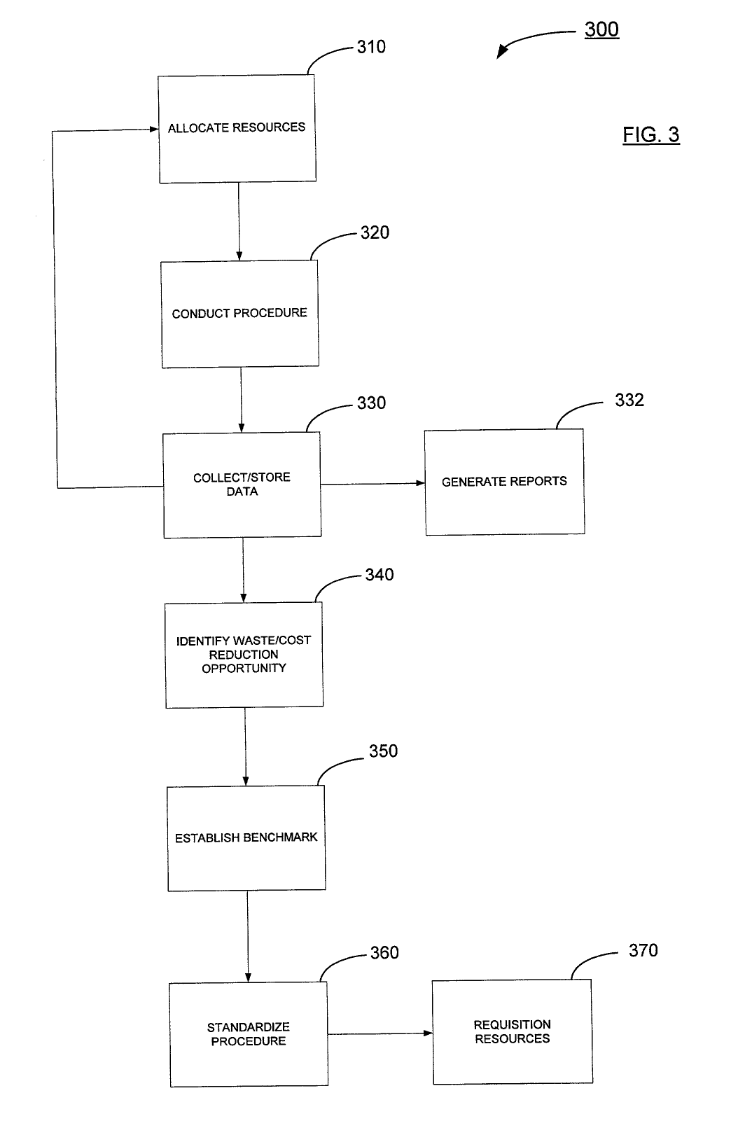

The present invention determines where the inefficient and ineffective aspects of a hospital exist. Once these aspects are located, a more profitable and improved quality practice may be developed. FIG. 3 illustrates a flowchart of one embodiment of a method 300 for measuring the operational efficiency and effectiveness of a clinical practice. The method 300 is implemented by allocating 310 the resources and conducting 320 a medical procedure. Then, in process block 330, the data from allocating the recourses and conducting the procedure is collected and stored in the database. For example, the costs associated with conducting a procedure are maintained to provide cost estimates in the future. Process blocks 310, 320 and 330 create a continuous loop wherein resources are allocated for the next procedure and data is collected for each of the procedures conducted at the medical facility.

After a procedure is completed, the process continues to block 340 where potential waste and cost reduction opportunities are identified as well as clinical outcomes. For example, because quality control monitors when a drug is to be used or may not be used, physicians may be rewarded for using the drug properly. Based upon the identified waste and cost reduction opportunities, a benchmark is established 350 as to the average utilization of resources for a particular type of procedure. The resources may be, for example, supplies, the type of room required, the number of hours the room is required, the number and type of assistant or staff personnel required, etc.

Once a benchmark is established, particular types of procedures may be standardized to include only necessary resources which are then requisitioned for future procedures based upon the benchmark requirements established for the standardized procedure. Supplies may be requested on a scheduled-basis based upon the benchmark requirements. Blocks 360 and 370 illustrate the steps of standardizing a procedure and requisitioning resources for a standardized procedure, respectively. The procedures are standardized by eliminating unnecessary resources as determined by the benchmarks. Once the benchmarks are established and procedures are standardized, supplies may be requisitioned automatically from vendors the supply room or from upon the scheduling of a clinical procedure. Preferably, when supplies are requisitioned from the supply room, the inventory is automatically updated and, when the inventory drops below a predetermined minimum replacement supplies are automatically ordered or a request for a piece quote for the supplies is automatically generated. Also, the costs associated with requisitioning supplies may be monitored to provide cost estimates or to evaluate price quotes.

Each procedure area in a medical facility has a cost basis for calculating the total costs and savings for a category of standardized procedures. For example, operating rooms are measured and evaluated by the total number of procedures in a particular category during a particular time period to determine the average benchmark operating room cost for that category. Operating costs are next measured during the period and divided by the total number of procedures in each category during the period to determine the average actual procedure room costs for each clinical category. The average benchmark procedure room costs are compared to average actual procedure room costs for each category to determine the average procedure room savings for each category. Then, fifty percent (50%) of the savings in each category may be shared with physicians.

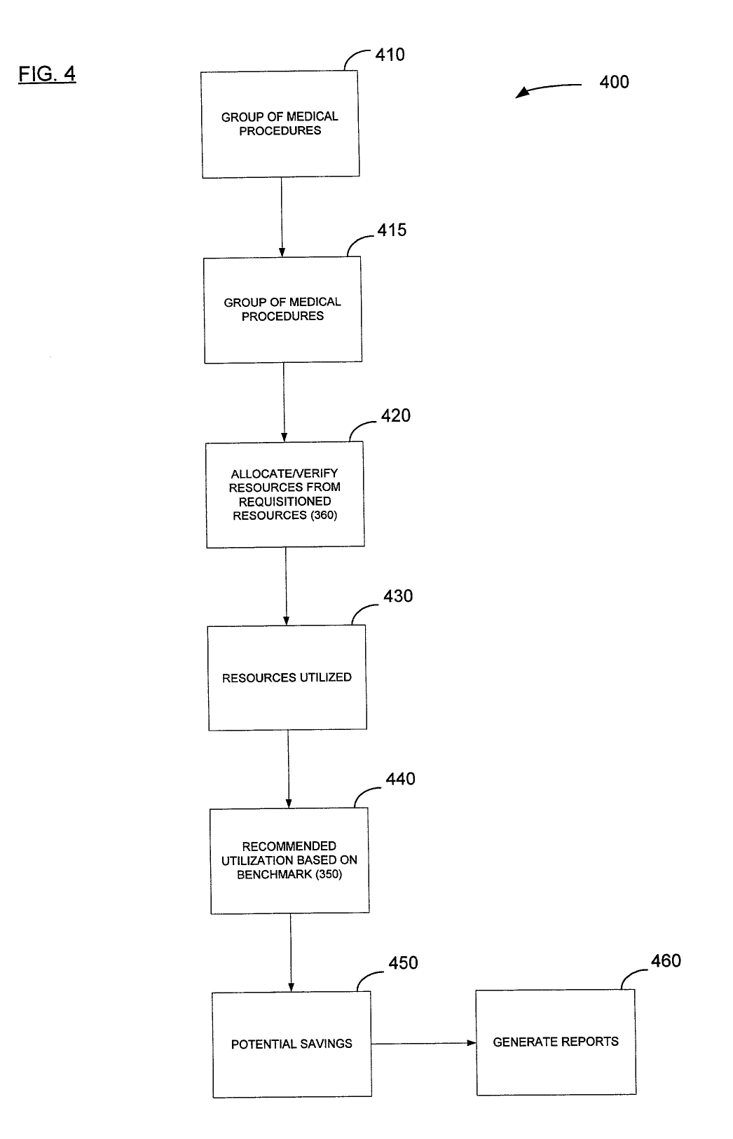

FIG. 4 illustrates one embodiment of a flowchart of a method 400 according to one embodiment of the present invention. In FIG. 4, block 410 represents a group of standardized medical procedures to be performed, preferably derived from the implementation of method 300 and the development of standardized procedures as represented in block 360 of FIG. 3. The desired medical procedure is identified 415 and the resources for the standardized procedure are allocated and verified as shown in block 420. The resources allocated 420 to the procedure identified in block 415 is at least a portion of the resources requisitioned in block 370. In block 430 the resources actually utilized while conducting the procedure of block 415 are measured and the information stored. Next, the recommended utilization represented in block 440 is compared with the actual utilization represented in block 430. The recommended utilization is based upon the benchmark established in block 350 of the method 300. The difference in the recommended utilization and the actual utilization is represented in block 450 as a potential savings. This method is performed for each type of procedure. Thus, physicians may be rewarded for issuing resources properly by allowing them to receive a share of the cost savings.

### EXAMPLE

The method 400 may be illustrated by the following example. Opportunities for reducing waste were identified by measuring the type and amount of supplies utilized in 1,508 open heart surgery related procedures performed at multiple medical facilities. Opportunities for waste reduction were identified in patient care and technical processes. The following types of open heart surgery cases are included in the analysis.

| Case Type | Volume |
|---|---|
| Coronary Artery Bypass (CABG) | 1,189 |
| Aortic Valve Replacement (AVR) | 76 |
| AVR with CABG | 56 |
| Mitral Valve Replacement (MVR) | 86 |
| MVR with CABG | 28 |
| AVR-MVR | 19 |
| Re-operations (bleeders, etc.) | 54 |
| TOTAL | 1,508 |

Waste Reduction Analysis

Opportunities for reducing waste were identified by the following:

(1)(a) Disposable products opened but not actually utilized in the procedure (e.g., valve surgery related products opened on CABG cases).

(b) Disposable products opened on an appropriate type of procedure but inconsistently used (e.g., retrograde cardioplegia cannulae opened on all CABG procedures but only utilized on a small percentage of procedures).

(c) Corrective action involves opening the products on a need to use only basis.

(2)(a) Excessive and wasteful utilization of disposable products as part of an appropriate surgical technique.

(b) An identical technical patient care process can be accomplished with less quantity of a product than is routinely opened and utilized (e.g., discharging large amounts of monofilament suture that can easily be utilized to perform additional suturing).

(c) Corrective action involves modification of technical processes to utilize less quantity of a product while achieving the identical final surgical result.

(3)(a) Excessive and wasteful utilization of disposable products in an inappropriate manner (e.g., utilization of pharmacologic agents that are not medically indicated according to medical literature).

(b) Corrective action involves modification of patient care processes by utilizing products only when medically indicated.

Waste Reduction Analysis

Numerous opportunities were identified for waste reduction. The following were targeted to calculate the total cost savings.

Cell Saver

The cell saver was set up on 81% of open heart surgery (OHS) cases, yet processed blood was only returned in 8% of cases. Usage can be reduced by not opening the disposable cell saver components unless excessive bleeding is recognized. The Heart-Lung machine's contents can be flushed back into the patient without the need for cell saver processing a ten percent utilization factor should be readily achievable without any change in patient care. By reducing usage to 10% of cases, the following estimated savings could be achieved.

| Current Utilization | |
|---|---|
| 1,508 OHS Cases * $130 * 81% = | $158,792.40 |
| Recommended Utilization | |
| 1,508 OHS Cases * $130 * 10% = | $19,604.00 |
| Potential Savings | $139,188.40 |

Medusa Tubing

(A) Medusa tubing was opened on all CABG cases, but it was not utilized on 36% of cases. Of the 64% of cases for which medusa tubing was utilized, Y tubing could have been substituted for 50% of the cases.

| Current Utilization | |
|---|---|
| 1,189 CABG Cases * $13.80 = | $16,408.20 |
| Recommended Utilization | |
| No Tubing: 1,189 Cases * $0.00 * 36% = | $0.00 |
| Medusa Tubing: 1,189 Cases * $13.80 * 32% = | $5,250.62 |
| Y Tubing: 1,189 Cases * $6.80 * 32% = | $2,587.26 |
| Total | $7,837.88 |
| Potential Savings | $8,570.32 |

(B) Medusa tubing was opened on all AVR with CABG and MVR with CABG cases, but it was not utilized on 36% of cases. Of the 64% of cases for which medusa tubing was utilized, Y tubing could have been substituted for half of the cases.

| Current Utilization | |
|---|---|
| 84 AVR w/CABG & MVR w/CABG Cases * $13.80 = | $1,159.20 |
| Recommended Utilization | |
| No Tubing: 84 Cases * $0.00 * 36% = | $0.00 |
| Medusa Tubing: 84 Cases * $13.80 * 32% = | $370.94 |
| Y Tubing: 84 Cases * $6.80 * 32% = | $182.78 |
| Total | $553.72 |
| Potential Savings | $605.48 |

Retrograde Cardioplegia Cannula

Retrograde Cardioplegia Cannula was opened on all valve cases and 32% of CABG cases, but it was only utilized on 71% of valves and 16% of CABGs.

| Current Utilization | |
|---|---|
| 265 Valve Cases * $63.00 = | $16,695.00 |
| 1,189 CABG Cases * $63.00 * 32% = | $23,970.24 |
| | $40,665.24 |
| Recommended Utilization | |
| 265 Valve Cases * $63.00 * 71% = | $11,853.45 |
| 1,189 CABG Cases * $63.00 * 16% = | $11,985.12 |
| Total | $23,838.57 |
| Potential Savings | $16,826.67 |

Jehle Coronary Perfusion Catheter

Jehle Coronary Perfusion Catheter was opened on 12% of AVR cases (AVR, AVR w/CABG and AVR-MVR), but was only utilized on 1% of cases.

| Current Utilization | |
|---|---|
| 151 (132 + 19) AVR Cases * $65.00 * 12% = | $1,177.80 |
| Recommended Utilization | |
| 151 (132 + 19) AVR Cases * $65.00 * 1% = | $98.15 |
| Potential Savings | $1,079.65 |

Surgicel

Surgicel was opened on 22% of OHS cases, but was only utilized on 1% of cases.

| Current Utilization | |
|---|---|
| 1,454 OHS Cases * $19.52 * 22% = | $6,244.06 |
| Recommended Utilization | |
| 1,454 OHS Cases * $19.52 * 1% | $238.82 |
| Potential Savings | $5,960.24 |

Teflon Felt Pledgets

Teflon Felt Pledgets were opened on 36% to 42% of OHS cases depending on the type of case (excluding re-operations). Autologous pericardium could be substituted at no cost for the same quality.

| Current Utilization | |
|---|---|
| 1,189 CABG Cases * $4.95 * 42% = | $2,471.93 |
| 132 AVR Cases * $495 * 36% = | $235.22 |
| 114 MVR Cases * $495 * 39% = | $220.08 |
| 19 AVR-MVR Cases * $4.95 *39% = | $36.68 |
| | $2,963.91 |
| Recommended Utilization | |
| 1,454 OHS Cases * $0 * 100% = | $0.00 |
| Potential Savings | $2,963.91 |

IMA Cannula

A 2MM IMA cannula is opened on all CABG, AVR with CABG and MVR with CABG cases, but only 91% of cases have an IMA. In addition, two of the surgeons do not cannulate the IMA. The net result is that even though an IMA cannula is opened 100% of the time, it is only utilized on 62% of cases.

| Current Utilization | |
|---|---|
| 1,273 (1,189 + 84) CABG Cases * $4.50 = | $5,728.50 |
| Recommended Utilization | |
| 1,189 CABG Cases * $4.50 * 62% = | $3,317.31 |
| 84 AVR and MVR w/CABG Cases * $4.50 * 62% = | $234.36 |
| | $3,551.67 |
| Potential Savings | $2,176.83 |

Avitene

One surgeon routinely opens Avitene on his OHS cases, accounting for 18% of the group's OHS cases (excluding re-operations). Avitene is only utilized on 1% of these cases so it should be opened on an “as needed” basis only.

| Current Utilization | |
|---|---|
| 1,454 (1,189 + 132 + 114 + 19) Cases * $36.35 * 18% = | $9,513.52 |
| Recommended Utilization | |
| 1,454 (1,189 + 132 + 114 + 19) Cases * $36.35 * 1% = | $528.53 |
| Potential Savings | $8,984.99 |

Bulldog

A 6 MM or 12 MM disposable bulldog was opened on all CABG, AVR with CABG and MVR with CABG cases, but only 62% of the cases had an IMA that required use of a bulldog.

| Current Utilization | |
|---|---|
| 1,273 (1,189 + 84) CABG Cases * $13.26 = | $16,879.98 |
| Recommended Utilization | |
| 1,273 (1,189 + 84) CABG Cases * $13.26 * 62% = | $10,465.69 |
| Potential Savings | $6,414.39 |

Gabby Fraser Suture Guide

A Gabby Fraser suture guide was opened on all valve cases (AVR, MVR and AVR-MVR), but was only utilized by some of the surgeons. The net result was that it was utilized on 52% of all valve cases.

| Current Utilization | |
|---|---|
| 265 (132 + 114 + 19) Valve Cases * $43.52 = | $11,532.80 |
| Recommended Utilization | |
| 265 (132 + 114 + 19) Valve Cases * $43.52 * 52% = | $5,997.06 |
| Potential Savings | $5,535.74 |

Connector

A 1/2×1/2 connector was opened on all valve cases, but was not utilized on any MVR or AVR-MVR cases and was only utilized on 74% of AVR procedures.

| Current Utilization | |
|---|---|
| 265 (132 + 114 + 19) Valve Cases * $3.40 = | $901.00 |
| Recommended Utilization | |
| 132 AVR Cases * $3.40 * 74% = | $332.11 |
| Potential Savings | $568.88 |

Pacing Wires

A 4-pack of pacing wires was opened on all OHS cases (excluding re-operations), but overall utilization was less than 4 wires. Pacing wire utilization varied by surgeon: 31% utilized 4 pacing wires, 11% utilized 3, 53% utilized 2 and 5% utilized 1. When appropriate, single pacing wire packages should be opened as an alternative.

| Current Utilization | |
|---|---|
| 1,454 (1,189 + 132 + 114 + 19) OHS Cases * $30.00 = | $43,620.00 |
| Recommended Utilization | |
| 1,454 OHS Cases * $30.00 * 31% = | $13,522.20 |
| 1,454 OHS Cases * $7.50 * 11% * 3 = | $3,598.65 |
| 1,454 OHS Cases * $7.50 * 53% * 2 = | $11,559.30 |
| 1,454 OHS Cases * $7.50 * 5% * 1 = | $545.25 |
| | $29,225.40 |
| Potential Savings | $14,394.60 |

Beaver Blade

A blue beaver knife blade was opened on all CABG cases, but was only utilized on 55% of cases.

| Current Utilization | |
|---|---|
| 1,273 (1,189 + 56 + 28) CABG Cases * $4.50 = | $5,728.50 |
| Recommended Utilization | |
| 1,273 (1,189 + 56 + 28) CABG Cases * $4.50 * 55% = | $3,150.68 |
| Potential Savings | $2,577.82 |

Distal Bypasses

The average number of distal bypasses on all CABG cases (excluding valve with CABG) was 2.7 and the average number of 7-0 or 8-0 sutures utilized was 1.47/distal anastomosis. It is possible to reduce distal suture utilization by using residual fragments for repairs. Furthermore, it has been empirically determined that suture utilization can be reduced to 1.15/distal by utilizing this technique.

| Current Utilization | |
|---|---|
| 1,189 CABG Cases * $10.10 * 2.7 distal/CABG* | $47,663.32 |
| 1.47 suture/distal = | |
| Recommended Utilization | |
| 1,189 CABG Cases * $10.10 * 2.7 distal/CABG * | $37,287.63 |
| 1.15 suture/distal = | |
| Potential Savings | $10,375.69 |

Distal IMA LAD Anastomosis

91% of CABG cases (excluding valves with CABG) involved use of an internal mammary to LAD anastomosis. Distal internal mammary to LAD anastomosis was performed with 7-0 (36% of cases) and 8-0 (64% of cases) monofilament sutures. Use of 8-0 suture is costly and wasteful at 64% utilization. It is recommended that 8-0 suture only be utilized on 32% of these cases. The following cost savings are based on suture/distal.

| Current Utilization | |
|---|---|
| 1,189 CABG Cases * $28.14/8-0 suture * | $19,486.21 |
| 91% IMA-LAD anastomosis/CABG * 64% = | |
| 1,189 CABG Cases * $8.56/7-0 suture * | $3,334.26 |
| 91% IMA-LAD anastomosis/CABG * 36% = | |
| | $22,820.47 |
| Recommended Utilization | |
| 1,189 CABG Cases * $28.14/8-0 suture * | $9,743.10 |
| 91% IMA-LAD anastomosis/CABG * 32% = | |
| 1,189 CABG Cases * $8.56/7-0 suture * | $6,298.05 |
| 91% IMA-LAD anastomosis/CABG * 68% = | |
| | $16,041.15 |
| Potential Savings | $6,779.32 |

Aprotinin

A full dose of aprotinin was administered on 86% of OHS patients (excluding re-operations). Medical literature supports the use of full dose aprotinin in patients with a higher risk of perioperative hemorrhage. Review of the OHS patient records from 1999 revealed that only 27% of patients were at higher risk for perioperative hemorrhage. Aprotinin should only be administered to these higher risk patients to eliminate the wasteful utilization of this costly medication.

| Current Utilization | |
|---|---|
| 1,454 OHS Cases * $900.00/full dose * 86% = | $1,125,396.00 |
| Recommended Utilization | |
| 1,454 OHS Cases * $900.00/full dose * 27% = | $353,322.00 |
| Potential Savings | $772,074.00 |

Amrinone

Amrinone was utilized on 22% of OHS patients (excluding re-operations) for weaning from cardiopulmonary bypass. An initial bolus of amrinone was administered and an amrinone drip was prepared. Analysis reveals that the drip was only administered in 6% of patients and mixing of this drip could easily be delayed until a clinical decision is made concerning the need to advance from bolus therapy to a maintenance drip.

| Current Utilization | |
|---|---|
| 1,454 OHS Cases * $46.84 (bolus) * 22% = | $14,983.18 |
| 1,454 OHS Cases * $140.52 (drip) * 22% = | $44.949.54 |
| | $59,932.72 |
| Recommended Utilization | |
| 1,454 OHS Cases * $46.84 (bolus) * 22% = | $14,983.18 |
| 1,454 OHS Cases * $140.52 (drip) * 6% = | $12,258.96 |
| | $27,242.14 |
| Potential Savings | $32,690.58 |

Cannualation Suture

Techniques in 1999 for aortic cannulation involved the use of three 3-0 monofilament sutures. Two were used for purse string sutures and the third for a reinforcing mattress stitch. Experience has shown the identical surgical process can be achieved using a long remnant of one 3-0 suture to create the mattress suture. It is anticipated that this wate reduction could be achieved in 90% of procedures.

| Current Utilization | |
|---|---|
| 1454 OHS Cases * $5.00 (3-0 prolene)*3 = | $21,810.00 |
| Recommend Utilization | |
| 1454 OHS cases * $5.00 (3-0 prolene)*2 = | $14,540.00 |
| 1454 OHS cases * $5.00 (3-0 prolene) * 1 * 10% = | $ 727.00 |
| Potential Savings | $ 6,543.00 |

Summary of Cost Savings Opportunities

| Procedure | Cost Savings |
|---|---|
| Cell Saver | $ 139,188.40 |
| Medusa Tubing-CABGs | $ 8,570.32 |
| Medusa Tubing-Valves | $ 605.48 |
| Retrograde Cardioplegia | $ 16,286.67 |
| Cannula | |
| Jehle Coronary Perfusion | $ 1,079.65 |
| Catheter | |
| Surgicel | $ 5,960.24 |
| Teflon Felt Pledgets | $ 2,963.91 |
| IMA Cannula | $ 2,176.83 |
| Avitene | $ 8,984.99 |
| Bulldog | $ 6,414.39 |
| Gabby Fraser Suture Guide | $ 5,535.74 |
| Connector | $ 568.88 |
| Pacing Wires | $ 14,394.60 |
| Beaver Blade | $ 2,577.82 |
| Distal Bypass | $ 10,375.69 |
| Distal IMA-LAD Anastomosis | $ 6,779.32 |
| Aprotinin | $ 772,074.00 |
| Amrinone | $ 32,690.58 |
| Cannulation Suture | $ 6,543.00 |
| TOTAL | $1,044,310.51 |

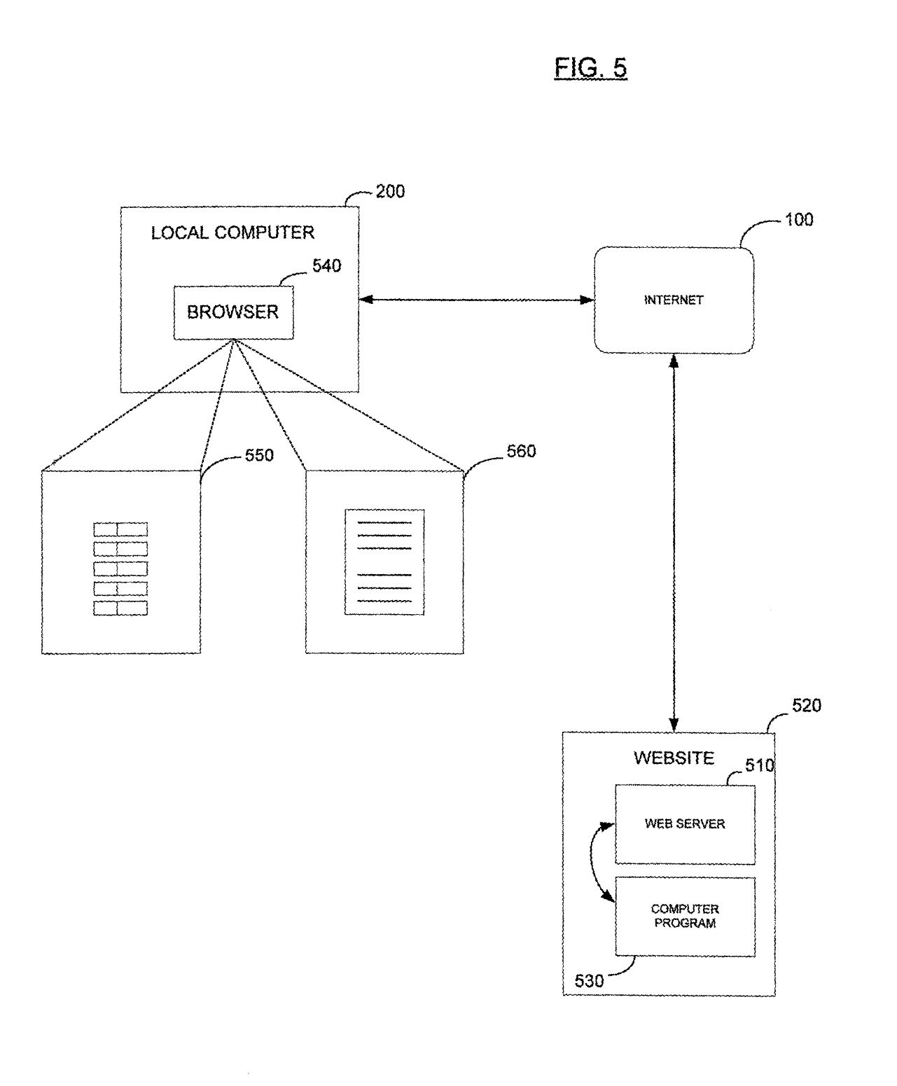

The method of the present invention may be implemented as a web-based application as shown in FIG. 5. This is advantageous where there are satellite offices of a large or regional system, or where several independent systems wish to collectively manage costs. Use of the Internet avoids the need for dedicated lines between the various offices, and the cost and delay of dial-up procedures between the various offices. In this exemplary embodiment, the present invention may be maintained on the network 100, such as the Internet or the World Wide Web. The network 100 is accessed by using a computer 200 and to contact a server 510 or a plurality of servers 510 at a web site 520 are contacted. A server 510 initiates a computer program 530 to conduct processing steps. The local computer 200 and the server 510 preferably communicate using the File Transfer Protocol. Alternatively, other protocol or formats such as the HTTP protocol can be used for uploading and downloading files and data. The server 510 locates and sends the information for practicing the present invention to a web browser 540 on the computer 200, which displays web pages having the requested information for the desired procedure or procedures. Web pages are represented in FIG. 5 as reference numerals 550 and 560. The web pages 550, 560 are utilized for entering or viewing data, outlining or viewing procedures, and/or for generating reports.

To view the files of the present invention, the user may utilize a helper application or a plug-in. The user configures the web browser to launch these helper applications or plug-ins which are then used for performing the various tasks described above. Some web browsers come configured with multiple plug-ins.

Hyperlinks may serve to connect one document or portion of a document to another and even one web site to another. For example, one document with the color representations may be linked to another document with the corresponding, predicted human behaviors. Various organizational structures may be used to connect the selected combinations of color representations with the appropriate corresponding, predicted human behavior.

In another embodiment, users can download software from a network, such as the World Wide Web, to be installed on the local computer to practice the methods as described above. Internal computer networks commonly referred to as Intranets may also be used.

The foregoing exemplary embodiments may be conveniently implemented in one or more program modules as well as hardware components. The present invention may conveniently be implemented in a program language such as “C”; however, no particular programming language has been indicated for carrying out the various tasks described because it is considered that the operation, steps, an procedures described in the specification and illustrated in the accompanying drawings are sufficiently disclosed to permit one of ordinary skill in the art to practice the instant invention. Moreover, in view of the many different types of computers, computer platforms and program modules that can be used to practice the present invention, it is not practical to provide a representative example of a computer program that would be applicable to this system. Each user of a particular platform would be aware of the language and tools which are more useful for that user's needs and purposes to implement the instant invention.

The present invention has been illustrated in relation to particular embodiments which are intended in all respects to be illustrative rather than restrictive. Those skilled in the art will recognize that the present invention is capable of many modifications and variations without departing from the scope of the invention. Accordingly, the scope of the present invention is described by the claims appended hereto and supported by the foregoing.

What is claimed is:

1. A method for increasing resource utilization efficiency and identifying areas to enhance quality, said method comprising the steps of:
collecting data for a clinical procedure performed at the point of patient care;
establishing a benchmark based upon at least a portion of said data; and
standardizing said clinical procedure based upon said benchmark.

2. The method of claim 1 further comprising the step of rewarding physicians' efforts to reduce costs by providing a share of savings in response to utilizing said standardized procedure.

3. The method of claim 1 wherein said collecting step comprises determining resources used in said clinical procedure.

4. The method of claim 1 wherein said establishing step comprises identifying resources to be used to establish said benchmark for said clinical procedure.

5. The method of claim 1 wherein standardizing step comprises setting the quantity of at least one resource to be used for said clinical procedure while correlating the clinical outcome.

6. The method of claim 1 further comprising the steps of accepting a request for said clinical procedure, and requesting resources to be utilized in said clinical procedure based upon said benchmark.

7. The method of claim 1 further comprising the steps of accepting a request for said clinical procedure, and allocating resources to said clinical procedure based upon said benchmark.

8. The method of claim 7 further comprising the step of verifying the existence of supplies in inventory.

9. The method of claim 7 further comprising the step of scheduling the requisitioning of supplies based upon said benchmark.

10. The method of claim 7 further comprising the step of automatically ordering supplies from vendors based upon the needs of the clinical practice based upon said benchmark.

11. The method of claim 1 further comprising the step of compiling a report of resources utilization based upon said data.

12. The method of claim 11 wherein said report comprises a clinical outcomes report.

13. The method of claim 11 wherein said report comprises a procedure results report.

14. The method of claim 11 wherein said report comprises a patient profile report.

15. The method of claim 11 wherein said report comprises information on medication used during said clinical procedure.

16. The method of claim 11 wherein said report comprises information on the length of stay of patients undergoing said clinical procedures.

17. The method of claim 11 wherein said report comprises information on the demographics of patients undergoing said clinical procedure.

18. The method of claim 1 wherein said collecting step comprises monitoring the cost of said clinical procedure to provide a benchmark.

19. The method of claim 1 wherein said collecting step comprises monitoring costs of requisitioned supplies.

20. The method of claim 1 wherein said collecting step comprises storing said data collected from performing said clinical procedures.

21. A computer-readable medium on which is stored a computer program for increasing resource utilization efficiency, and identifying areas to enhance quality, said computer program comprising instructions which, when executed by a computer, perform the steps of:
collecting data for a clinical procedure performed at the clinical practice and entering said data on said web page;
establishing a benchmark based upon at least a portion of said data; and
standardizing said clinical procedure based upon said benchmark characteristic.

22. A method enabling a user to increase resource utilization efficiency, and identifying areas to enhance quality, using a computer and a telecommunications link between the computer and the web site, the method comprising the steps of:
providing a web page to the computer;
collecting data for a clinical procedure performed at the clinical practice and entering said data on said web page;
establishing a benchmark based upon at least a portion of said data; and
standardizing said clinical procedure based upon said benchmark.

23. A hypermedia document for measuring operational efficiency and effectiveness of a clinical practice and identify areas to enhance quality, said hypermedia document comprising:
a plurality of hyperlinks providing access to a plurality of files stored on a web site, at least one of said files being adapted for performing the following steps:
collecting data for a clinical procedure performed at the clinical practice;
establishing a benchmark based upon at least a portion of said data; and
standardizing said clinical procedure based upon said benchmark.
